(19) United States
(12) Patent Application Publication
(10) Pub. No.: US 2003/0034234 A1
(43) Pub. Date: Feb. 20, 2003

(54) Device for guiding belts for transporting flat materials

(76) Inventor: Norbert Neumann, Westensee/Brux (DE)

Correspondence Address: Lawrence P. Kessler, Patent Department, NexPress Solutions LLC, 1447 St. Paul Street, Rochester, NY, 14653-7103, US

(21) Appl. No.: 09/850,602

(22) Filed: May 7, 2001

(30) Foreign Application Priority Data
May 12, 2000 (DE) 100 23 151.9

(51) Int. Cl. B65G 15/60

(52) U.S. Cl. 198/840

(57) ABSTRACT

The invention concerns a conveyor belt arrangement for transporting and/or turning flat material, transport surfaces (2) of belts (2) receiving a twisting and being guided over rotating, disk-like guide elements (1, 11), the guide elements (1, 11) being provided with a recess (22) guiding the belts (5), wherein the recess (22) is bordered by surfaces (16; 17, 18, 19), one of which is electrically conducting and edges (17, 18, 19) contain friction-reducing materials or consist of the latter.

The invention concerns a device for guiding belts for transporting flat material in a to a machine processing sheet-like material.

In addition to transferring torques in the case of conveyor facilities or in the case of combustion engines in the automobile field, belt drives also are used for transporting flat copies, such as, for example, sheet-like material in sheet processing machines. Belt drives, which include belts provided with trapezoidal cross-section, are used in copying devices or also in the case of printing presses and there transport the material in each case to be printed on one side or both sides by the printing press or other sheet-processing machines.

The belt drive can be used, for example, for transporting sheets to individual transportation or also for sheet turning.

If conveyor belts are used for turning flat materials from the front side of the flat material to the back side of the flat material and vice versa, turning devices performing turning also can be provided with belts which can be twisted by up to 180° and more, with respect to their respective longitudinal axis. The belts are pre-stressed, by means of which a high friction force is exerted on the belt pulleys guiding the belts in each case. Because of a twisting by 180° and more, on the beveled edges of the belt pulley, which, for example, is made V-shaped, the conveyor belt tends to run up and jump from the belt pulley. If this occurs, the feed of flat material to a continuously operating sheet-processing machine is interrupted, and the printing process or another processing operation must be interrupted.

The former attempts to eliminate this defect consisted in wetting the edges of the belt with silicon oil in order to keep it slippery, to prevent the belt from running up on the belt pulley. In the case of sheets to be printed, which either are still fully unprinted, or one side of which already is printed, the use of silicon oil is excluded, since, for example in the case of open-porous printing materials, it penetrates the latter, which must lead to a loss of quality in the subsequent finished printed product.

Further, an attempt was made to integrate guide rollers into the belt travel path of the belt arrangement, which, on the one hand, is only of insufficient help, and on the other hand is very expensive and considerably limits the accessibility to the sheet conveying level.

Therefore the object of the invention is to increase the transportation reliability significantly in the case of the use of conveyor belts for transportation of printed materials and to simplify the turning of the printed material

According to the invention this object is achieved by the features of patent claim 1.

The advantages of the solution proposed according to the invention are especially to be seen in the fact that with the solution proposed according to the invention the tension, and thus the friction between the revolving belt and the guide pulley conveying the latter, must not be reduced. This means maintaining a high tension and an exact turning. The coefficients of friction between the walls of the revolving belt and the edges of the guide pulleys are reduced by an appropriate pairing of materials in such a way that run-up of the belt as a result of a friction created by the by the tension in the belt now ceases. Thus the danger of a revolving belt jumping out of its guiding belt pulley is reduced significantly, by which a continuous sheet feed in a sheet-processing machine may be obtained. In addition to this a corresponding design of the bottom of the element guiding the belt in each case, ensures that electrostatic charging in the belt with the printing material transported on the latter ceases, since the electrostatic charge can flow off over the bottom of the guide element.

In an advantageous embodiment of the concept upon which the invention is based, the recess guiding the belt in the guide element, for example made in trapezoidal shape, can consist of electrically conducting material or contain electrically conducting material. In particular, a metallic surface, which extends along the bottom surface over the guide element, is particularly suited as electrically conducting material.

In a further embodiment of the concept upon which the invention is based, the side surfaces bordering the, for example, trapezoidal recess, are made out of a material with good sliding properties. Fully synthetic materials such as PTFE (Teflon) or also a fully synthetic material such as, for example, PEEK, are particularly suited for this. In addition to the complete surface preparation of the side surfaces made of the synthetic materials named, the side surfaces also can just as well contain the synthetic material named, for example in the form of a coating. In this way, for example the material of the respective guide element lying under the fully synthetic coating can be an inexpensive material, since only the contact surface of the guide element for the belt has to be equipped with the friction-reducing coating.

A further possibility for the realization of the solution according to the invention consists in providing the side surfaces laterally bordering the recess with a friction-reducing side coating. In particular this makes it possible to provide guide elements already in operation with a corresponding coating reducing the friction with the revolving belt elements, so that turning units for printed material, reequipped in this way, are less subject to problems. In one embodiment of the concept underlying the invention the side surfaces bordering the recess, for example made in trapezoidal shape, are made as components mounted capable of turning around the common axis of rotation of the guide element. By avoiding relative motions between the edges of the guide element and the side areas of the conveyor belt, the run-up effect can be effectively suppressed.

In further embodiments of the concept underlying the invention, the disk-like guide elements can consist of individual disks held coaxial to one another on a common rotational axis. For this, for example, an individual pulley provided as a bearing surface between edge surfaces, can be made completely out of metallic material or provided with a metallic coating. The edge elements also just as well can be made out of an inexpensive synthetic material and subsequently receive the above-mentioned friction-reducing coatings.

The disk-like guide elements proposed according to the invention preferably can be used in the case of turning devices for turning sheet-like material, as are used, for example, in sheet-processing rotary printing presses. Sheet-processing rotary printing presses expressly also include those rotary printing presses which operate according to the digital principle and in which imaging units can be provided or which apply a printed image, applied by means of a toner, onto one or both sides of the printing material.

The invention is described in greater detail below by means of the drawing.

Here:

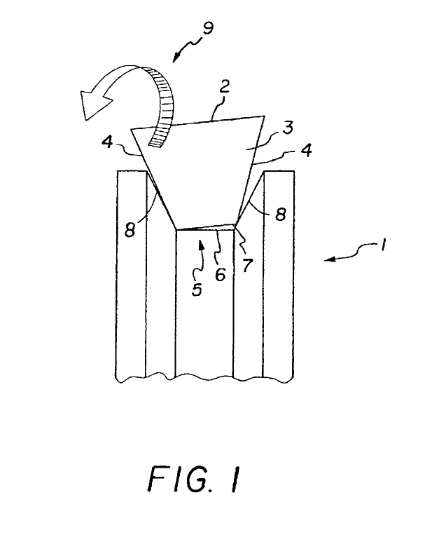

FIG. 1 shows the course of a belt from a belt pulley guiding the latter through run-up onto the belt pulley edge,

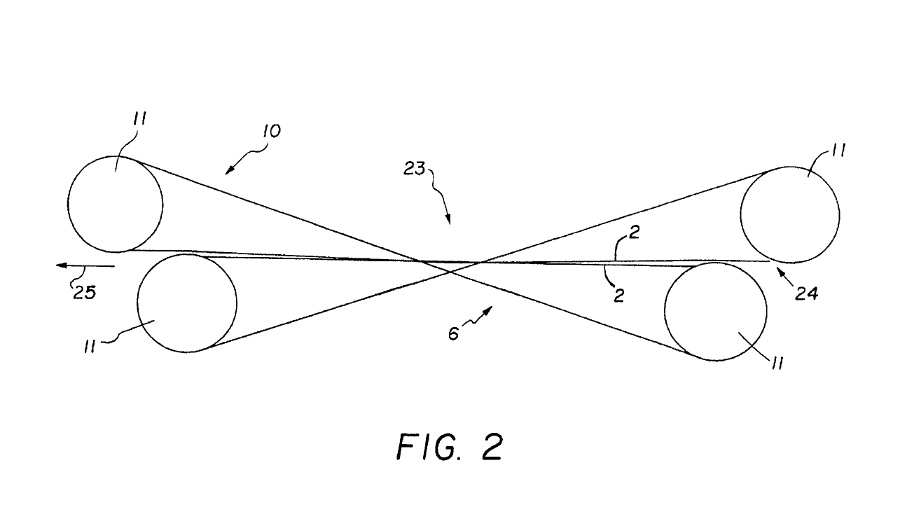

FIG. 2 shows a turning unit with a cross-over path of conveyor belts for turning sheet-like material,

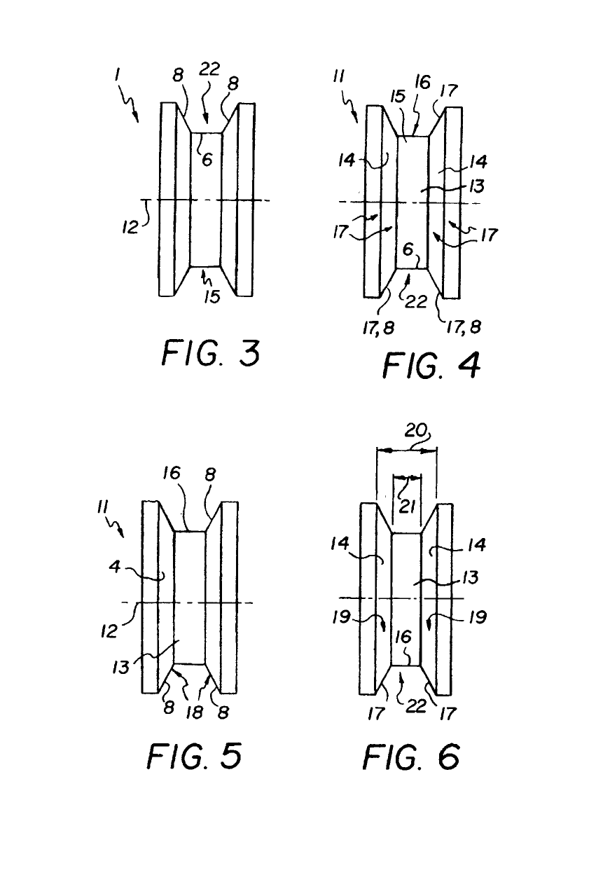

FIG. 3 shows a belt pulley made of fully metallic material in accordance with the prior art,

FIG. 4 shows a belt pulley with edges made of materials capable of sliding,

FIG. 4 shows a belt pulley, the edges of which are provided with a friction-reducing coating, and

FIG. 6 shows a belt pulley with edge elements mounted capable of turning, made out of fully synthetic material having sliding properties, held coaxially on a rotational axis.

FIG. 1 shows the phenomena of belt run-up onto an edge of the belt pulley, appearing during the operation of belts guided twisted in the case of transport, such as, for example, in the case of turning.

From FIG. 1 it follows that a belt pulley 1, which, for example, is made out of fully metallic material, has an approximated trapezoidally configured recess on the peripheral area. The trapezoidally configured recess is bordered by a bearing surface 6 as well as two edge surfaces 8 passing obliquely outward from the latter. The belt 5 guided in this recess contains a transport surface on its upper side, which is the surface which supports the sheet-like material to be conveyed as well as two edge areas 4, which are made tapering trapezoidally downward onto a bearing surface of the belt. The belt 5 shown in FIG. 1 is subjected to a tension perpendicular to the drawing plane, with which tension it is pre-stressed, for example within a turning module of a sheet-processing machine. The belt 5 is pressed onto the bearing surface 6 of the belt pulley 1 by the tension, as a result of which friction is established between the edges 4 of the belt 5 and the edge areas 8 of the belt pulley 1. As a result of the friction and the twisting inherent in the tightened belt 5, the latter tends toward a motion according to the arrow 9 drawn, with which motion it wanders out of the belt pulley 1, jumps from the latter, and thus causes a disturbance of the continuous feed of sheet-like material to a sheet-processing machine.

A turning unit for sheet-like material with a crossover path of conveyor belts for turning sheet-like material follows from the representation according to FIG. 2. The turning unit 23, reproduced here only in a schematic representation, includes an inlet opening 24 for sheet-like material and an outlet opening 25 for sheet-like material and an outlet opening 25 for sheet-like material, at which the sheet-like material again leaves the turning unit 23 in the turned condition.

The turning unit 23 essentially consists of belts 5 guided crossed-over, which are held on guide elements 11 in each case. The guide elements, in the plane lying over the sheet inlet plane, stand somewhat further from one another than the guide elements 11 lying under the sheet inlet plane 24. The conveyor belts configured, for example, trapezoidally or V-shaped, revolving around the respective guide elements are guided crossed-over, by means of which a sheet-like material entering at the inlet opening 24 is turned during the passage of the conveyor belts 5 guided crossed-over and leaves into the turning unit 23 in the turned condition at 25.

FIGS. 4, 5, and 6 show the guide elements 11 according to FIG. 2 in different embodiments.

A belt pulley made of fully metallic material according to the prior art is shown in FIG. 3.

The belt pulley 1 rotates around a rotational axis 12 and has a recess 22 configured essentially trapezoidally. The underside of the recess 22 consists of a bearing surface 6 made of a metallic material, while the edges 8 also consist of metal in the representation shown according to FIG. 3.

A belt pulley with edges made of material with friction-reducing properties follows from the representation shown according to FIG. 4.

The belt pulley 11 according to FIG. 4 includes a bearing surface 6 made of a metallic material or containing a metallic material. By making the bearing surface 6 out of electrically conducting material a possible electrostatic charge can be prevented, respectively an electrostatic charge can be shunted off immediately. The edges 17 consist of fully synthetic material, such as, for example PTFE (Teflon) or PEEK, just as the side surfaces of the belt pulley 11 adjacent thereto. The belt pulley 11 rotates around the rotational axis 12 and according to the configuration according to FIG. 4 has an electrically conducting material on the bottom of the trapezoidal recess 22 and a friction-reducing material on the edges of the trapezoidal recess 22 or consists of a friction-reducing material in this area.

In the configuration of the subject of the present invention in the configuration according to FIG. 5, the belt pulley 11, which rotates around a rotation axis 12, for example consists of a synthetic material, the bottom surface of the recess again containing a metallic material 16. This surface also can be made fully out of metallic material, in which case the edges 17 bordering the recess 22 can be made with a friction-reducing coating. In this way, for example, guide pulleys already delivered and in operation can be provided with a friction-reducing coating, so that the advantages obtained according to the invention also can be obtained in the case of sheet-processing machines already delivered. The coating of the edges with a friction-reducing material also permits the basic part of the belt pulley to be made out of an inexpensive material and then to coat the areas in contact with the belts with materials, such as, for example, PTFE or PEEK, and thus to reduce the production costs.

In a further embodiment of the solution according to the invention proposed according to FIG. 6, the belt pulley 11, rotating around a common belt axis 12, can contain a bearing surface 16 made of metallic material, held stationary on the rotational axis 12, which can be bounded on both sides by edge elements 14 made of plastic with friction-reducing properties, mounted capable of turning. Thus the trapezoidally configured recess guiding the belts 5 is made out of a stationary bottom surface with edge sections movable relative to the latter, so that no relative motions and consequently no friction arises between the conveyor belt 5 and the edges rotating with the latter. In this way a run-up of the conveyor belt 5 onto the edges of the trapezoidally configured recess 22 is effectively prevented, since a frictional force required for this cannot arise between the friction partners.

In a further configuration of the concept upon which the invention is based, the belt pulley can be composed out of up to five individual elements. Consequently, a central operating element 13, which is bordered by two edge elements 14, can be held on a rotation axis 12. The edge elements 14 for their part can be enclosed by side surfaces 15, in the case of this configuration the edge elements 14 can be held both stationary with respect to the rotational axis 12 as well as be mounted capable of turning relative to the latter as already shown. Analogous to the embodiments already shown above, the operating elements 13 may be provided, for example, with a ring-shaped peripheral metallic surface or with a surface, which contains electrically conducting material. The edge elements 14 for their part can be made out of fully synthetic material such as, for example, PTFE or PEEK, or contain these synthetic materials with friction-reducing properties in their surfaces. Only the surfaces are connected with the belt 5 guided in the trapezoidally configured recess 22 and consequently must create the friction-reducing properties. The side surfaces 15, which bound the belt pulley 11 arrangement put together, can be made out of any material. The trapezoidal recess 22 expands in the radial direction as seen from a narrow width formed by the bearing surface 16 to a widest opening 20, into which, for example, the radii of the edge elements 14 run. The recess 22 is configured so that a conveyor belt 5 held in the latter projects with its surface 2 by a few millimeters over the peripheral surfaces of the side surfaces 15, in order to prevent contact of the sheet-like material with these peripheral surfaces.

1. A conveyor belt arrangement for transporting and/or turning flat material, transport surfaces (2) of belts (2) receiving a twisting and being guided over rotating, disk-like guide elements (1, 11), the guide elements (1, 11) being provided with a recess (22) guiding the belts (5), wherein the recess (22) is bordered by surfaces (16; 17, 18, 19), one of which is electrically conducting and edges contain friction-reducing materials or consist of the latter.

2. The conveyor belt arrangement according to claim 1, wherein the bottom (16) of the recess (22) contains electrically conducting material.

3. The conveyor belt arrangement according to claim 2, wherein the bottom (16) of the recess (22) contains a metallic material.

4. The conveyor belt arrangement according to claim 1, wherein the side surfaces (17) bordering the recess (22) consist of a friction-reducing material

5. The conveyor belt arrangement according to claim 4, wherein the side surfaces (17) consist of fully synthetic material (PTFE).

6. The conveyor belt arrangement according to claim 4, wherein the side surfaces (17) consist of fully synthetic material (PEEK).

7. The conveyor belt arrangement according the claim 4, wherein the side surfaces (17) of the recess (22) contain PTFE and/or PEEK.

8. The conveyor belt arrangement according to claim 1, wherein the side surfaces (18) bordering the recess (22) are provided with a friction-reducing side coating.

9. The conveyor belt arrangement according to claim 1, wherein the edge areas (19) bordering the recess (22) are made as components mounted capable of turning around the rotational axis (12).

10. The conveyor belt arrangement according the claim 1, wherein the guide elements (11) are composed out individual elements (13, 14, 15) held on a common rotational axis (12).

11. The conveyor belt arrangement according to claim 19, wherein the operating element (13) contains a bearing surface (16) made of metallic material.

12. The conveyor belt arrangement according to claim 10, wherein the edge elements (14) are made out of fully synthetic PTFE or PEEK.

13. The conveyor belt arrangement according to claim 10, wherein the edge elements (14) are provided with a friction-reducing coating (18).

14. A turning unit for turning sheet-like material with a conveyor belt arrangement, transport surfaces (2) of belts (5) experiencing a twisting and being guided over rotating, disk-like guide elements (1, 11), the guide elements (1, 11) being provided with a recess (22) guiding the belt (5), wherein the recess (22) is bordered by surfaces (16; 17, 18, 19), one of which is electrically conducting and edges contain friction-reducing materials or consist of the latter.

15. a sheet-processing machine with a conveyor belt arrangement for transporting and/or turning flat material, transport surfaces )2) of belt (5) experience a twisting and are guided over rotating, disk-like guide elements (1, 11), the guide elements (1, 11) being provided with a recess (22) guiding the belt (5), wherein the recess (22) is bordered by surfaces (16; 17, 18, 19), one of which is electrically conducting and edges contain friction-reducing materials or consist of the latter.

16. Digital printing press with a conveyor belt arrangement for transporting and/or turning flat material, transport surfaces (2) of belt (5) experience a twisting and being guided over rotating, disk-like guide elements (1, 11), the guide elements (1, 11) being provided with a recess guiding the belt (5), wherein the recess (22) is bordered by surfaces (16; 17, 18, 19), one of which is electrically conducting and edges contain friction-reducing materials, or consist of the latter.
Reference Number List
1 belt pulley
2 belt transport surface
3 belt cross-section
4 belt edges
5 belt
6 belt pulley bearing surface
7 belt bearing surface
8 edges
9 operating motion
10 belt path
11 belt pulley
12 rotational axis
13 operating element
14 edge element
15 side surface
16 metallic surface
17 edge capable of sliding
18 edge coating
19 edge mounted capable of turning
20 widest opening
21 narrowest opening
22 bearing surface trapezoidal cross-section
23 turning modulus
24 inlet opening
25 outlet opening
